(19) United States
(12) Patent Application Publication
(10) Pub. No.: US 2001/0010582 A1
(43) Pub. Date: Aug. 2, 2001

(54) Carriage securing structure for image processor

(76) Inventors: Eiichi Hayashi, Ohmiya-shi (JP); Tetsuo Obata, Ohmiya-shi (JP); Hideyuki Sekiguchi, Ibaraki-ken (JP); Akira Yasuda, Ibaraki-ken (JP)

Correspondence Address: PRICE HENEVELD COOPER DEWITT & LITTON, 695 KENMOOR, S.E., P O BOX 2567, GRAND RAPIDS, MI, 49501, US

(21) Appl. No.: 09/756,420

(22) Filed: Jan. 8, 2001

(30) Foreign Application Priority Data
Jan. 13, 2000 (JP) 2000-004331

(51) Int. Cl. H04N 1/04

(52) U.S. Cl. 358/474

(57) ABSTRACT

A carriage securing structure for an image processor, including a stop which is linked by a captive coupling to a bottom plate of a casing so that it does not come off the bottom plate and an engagement member provided in a carriage. The carriage is secured by the stop engaging the engagement member. With the engagement being released, a through hole through which the stop is inserted encloses the hole in the bottom plate and does not degrade the appearance of the apparatus, and dust, or the like, is prevented from entering the casing through the hole.

### BACKGROUND OF THE INVENTION

1. Field of the Invention

The present invention relates to an image processor for scanning an original with light from a light source lamp by moving the light source lamp so as to read the image information from the original through reflected light therefrom. More particularly, the present invention relates to a carriage securing structure for securing a carriage which is movable for the scanning operation of the image processor so that the carriage is not moved unintentionally while the image processor is being moved from one place to another.

2. Description of the Related Art

An image processor of a stationary original type performs a scanning operation for obtaining the image information line by line by moving the light source lamp with respect to an original, which is placed, on a platen glass. FIG. 6 is a perspective view generally illustrating the structure of an image processor of this type. The image processor 1 comprises a casing 2 which includes a support plate 2b in the form of a stepped portion on the inner side of a longitudinal wall 2a of the casing 2. A full rate carriage 3 and a half rate carriage 4 are placed on the support plate 2b so that the carriages 3 and 4 are moved along the longitudinal direction of the casing 2 while being guided by the support plate 2b. A platen glass (not shown) is attached to the upper surface of the casing 2, and an original is placed on the platen glass. A fluorescent lamp 5 as a light source lamp is mounted on the full rate carriage 3, and the original is illuminated by the fluorescent lamp 5. An imaging lens 6 and a photoelectric conversion device 7 such as a CCD (charge coupled device) are provided in appropriate positions on a bottom plate 2c of the casing 2.

The full rate carriage 3 is provided with a first reflector (not shown), and the half rate carriage 4 is provided with a second reflector (not shown) and a third reflector (not shown). The light from the fluorescent lamp 5 is reflected by the original, and then by the first, second and third reflectors in this order. Then, the light passes through the imaging lens 6 so as to be incident upon the photoelectric conversion device 7. Thus, the first, second and third reflectors together form an optical path from the original to the photoelectric conversion device 7. In order to obtain the image information of the original, it is necessary to illuminate the entire area of the original. Accordingly, the full rate carriage 3 is provided so that the full rate carriage 3 can be moved across the entire area of the platen glass. The optical path length to the photoelectric conversion device 7 needs to be constant in spite of the movement of the full rate carriage 3. Therefore, the half rate carriage 4 is moved in synchronism with the full rate carriage 3 with the amount of movement thereof being about ½ of that of the full rate carriage 3 so as to keep the optical path length constant.

As described above, in the image processor 1, the full rate carriage 3 and the half rate carriage 4 need to be moved for the scanning operation. However, while the image processor 1 is being moved, the carriages 3 and 4 need to be secured. Otherwise the carriages 3 and 4 may be moved unintentionally to hit the casing 2. Therefore, while the image processor 1 is being moved, the carriages 3 and 4 are secured to the casing 2, etc., so that the carriages 3 and 4 cannot be moved unintentionally.

A conventional carriage securing structure is a securing screw or a securing pin, which is inserted through the side wall 2a of the casing 2 and coupled with the carriages 3 and 4 to secure the carriages 3 and 4 so that the carriages 3 and 4 cannot be moved unintentionally. After the image processor 1 is installed in the intended place, the securing screw or the securing pin is decoupled from the carriages 3 and 4 so as to release the carriages 3 and 4.

However, with the conventional securing structure as described above, after the carriages 3 and 4 are released, there remains a through hole through which the securing screw or the securing pin is inserted. Therefore, dust, or the like, may enter the casing 2 through the through hole. Moreover, the presence of the through hole in the sidewall 2a may degrade the appearance of the apparatus.

### SUMMARY OF THE INVENTION

In view of such problems in the prior art, an object of the present invention is to provide a carriage securing structure for an image processor which does not leave, after the carriage is released, a through hole which would otherwise allow dust, or the like, to enter the casing, and degrade the appearance of the apparatus.

As technical means for achieving the object, the present invention provides a carriage securing structure for an image processor which obtains image information of an original by scanning the original while successively changing a position of illumination by moving a light source lamp mounted on a carriage in a casing with respect to the original, the carriage securing structure comprising: stop means which is linked with a bottom plate of the casing and which does not come off the bottom plate; and an engagement member provided in the carriage, wherein: the stop means and the engagement member can be engaged with and disengaged from each other; and the carriage is secured while the stop means and the engagement member are engaged with each other.

When moving the image processor from one place to another, the carriage can be secured by engaging the stop means with the engagement member, thereby preventing the carriage from being moved unintentionally. After the image processor is installed in the intended place, the stop means is released from the engagement member. Thus, the carriage is released to be movable. After the stop means is released from the engagement member, the stop means is still linked with the bottom plate of the casing. Therefore, the through hole through which the stop means is inserted is occupied by the stop means, whereby the through hole is not left open. Furthermore, since the stop means is linked with the bottom plate of the casing, the stop means does not substantially degrade the appearance of the image processor.

In one embodiment, the present invention provides a carriage securing structure for an image processor, wherein: the stop means is provided as a securing screw; and the engagement member is provided as a threaded portion into which the securing screw is screwed.

The securing screw and the threaded portion can be coupled with each other to secure the carriage by rotating and tightening the securing screw into the threaded portion. The carriage can be released to be movable by releasing the screw-engagement between the securing screw and the threaded portion.

In one embodiment, the present invention provides a carriage securing structure for an image processor, wherein: the securing screw is a male screw having a guiding portion at a tip portion thereof, the guiding portion being formed by a partial spherical surface; and the threaded portion is an internal thread which is provided in a top portion of a concave wall provided in the carriage, the concave wall having a generally conical inner surface.

When one attempts to screw the securing screw into the threaded portion, the tip of the securing screw is guided to the top portion along the inner surface of the concave wall so as to be screwed into the threaded portion. Thus, it is possible to facilitate the screw-engagement of the securing screw into the threaded portion.

The carriage to be secured may be either one or both of a half rate carriage and a full rate carriage.

The nature, principle, and utility of the invention will become more apparent from the following detailed description when read in conjunction with the accompanying drawings in which like parts are designated by like reference numerals or characters.

### BRIEF DESCRIPTION OF THE DRAWINGS

FIG. 1 is a partial cross-sectional side view of an image processor incorporating a carriage securing structure according to the present invention;

FIG. 2 is an enlarged fragmentary cross-sectional view illustrating the carriage securing structure according to the present invention, showing the carriage being secured;

FIG. 3 is a cross-sectional view similar to FIG. 2 illustrating the carriage securing structure according to the present invention, showing the carriage being released;

FIG. 4 is a vertical cross-sectional side view of an image processor incorporating a carriage securing structure according to the present invention, showing the carriage in a secured position;

FIG. 5 is a vertical cross-sectional side view of the image processor incorporating the carriage securing structure according to the present invention, showing the carriage in a released position; and

FIG. 6 is a perspective view generally illustrating the structure of an image processor.

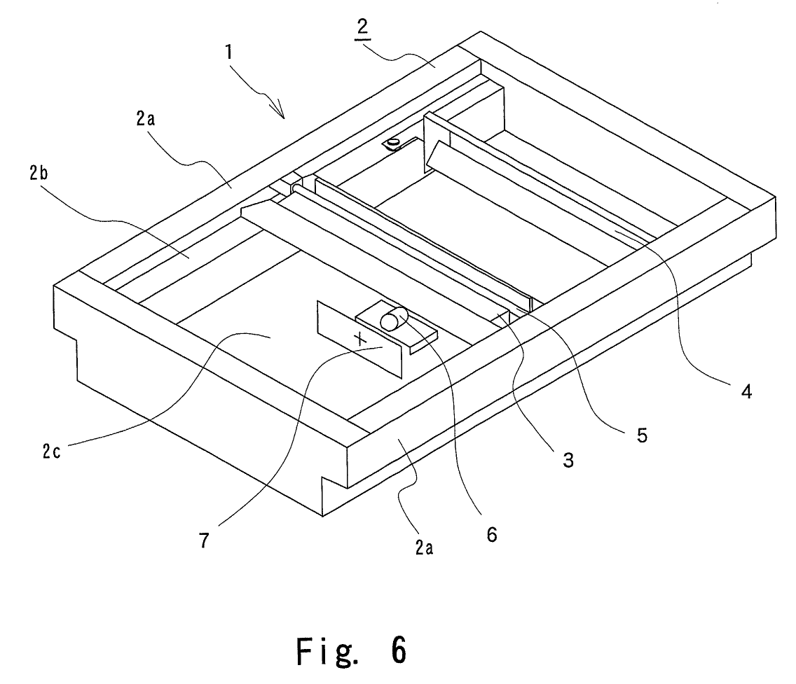

### DETAILED DESCRIPTION OF THE EMBODIMENTS

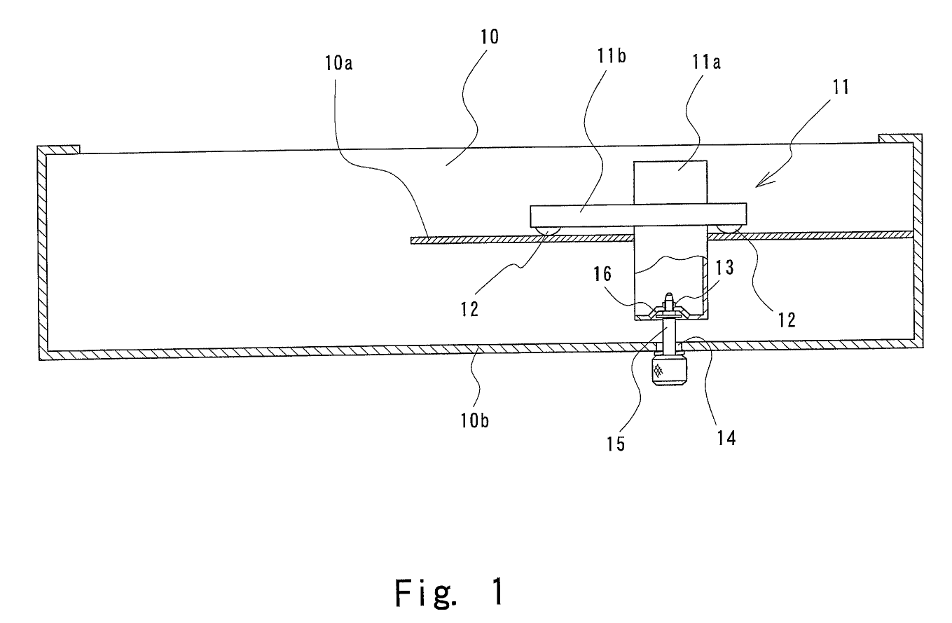

A carriage securing structure for an image processor according to the present invention will now be specifically described based on a preferred embodiment thereof illustrated in the figures. In this embodiment, a structure for securing a half rate carriage will be described. FIG. 1 is a cross-sectional side view illustrating an image processor incorporating the carriage securing structure according to the present invention, wherein some elements are not shown. A half rate carriage 11 is mounted on a support plate 10a which is provided in a casing 10 so that the half rate carriage 11 can slide on the support plate 10a. The half rate carriage 11 includes a carriage portion 11a to which the reflectors are attached and supports 11b, which are provided at opposite ends of the carriage portion 11a. The supports 11b are mounted on the support plate 10a via legs 12, which are respectively attached to the supports 11b.

A female threaded socket 13 serving as an engagement member is provided in an appropriate position of the carriage portion 11a. A through hole 14 is provided in a portion of a bottom plate 10b of the casing 10 which faces the female threaded socket 13 with the half rate carriage 11 being located at a secured position. A securing screw 15 serving as stop means is inserted through the through hole 14. The securing screw 15 can be screwed into the female threaded socket 13.

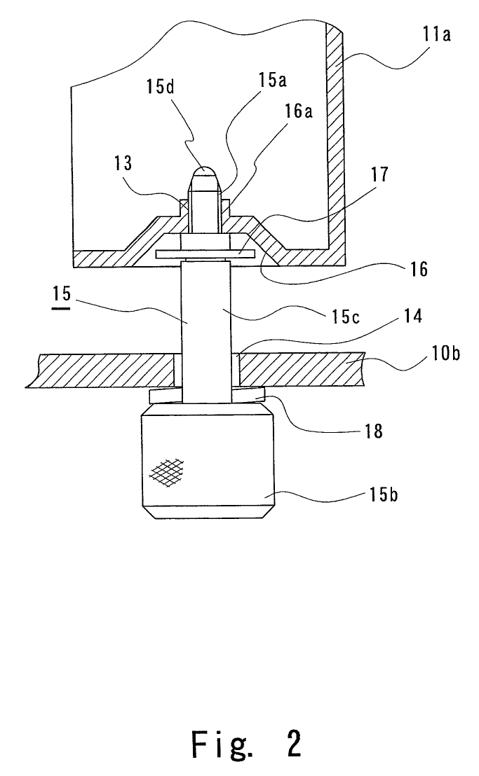

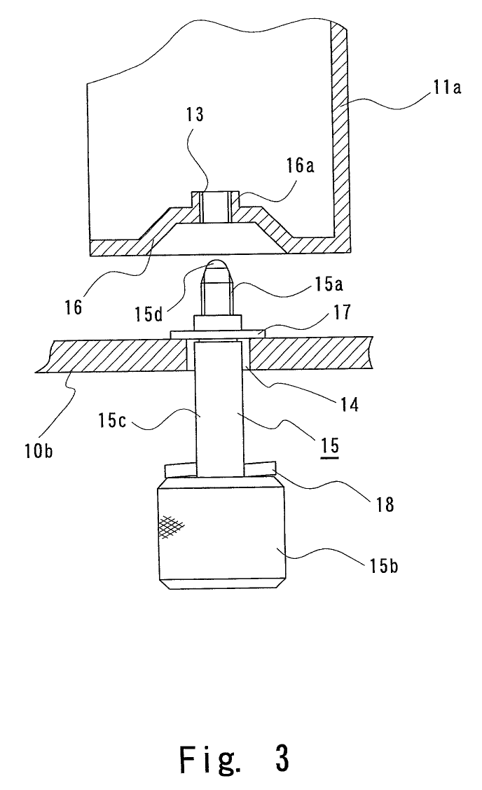

FIGS. 2 and 3 are enlarged cross-sectional views illustrating the relationship between the female threaded socket 13 and the securing screw 15, wherein FIG. 2 illustrates a state where the securing screw 15 is screwed into the female threaded socket 13, and FIG. 3 illustrates a state where the securing screw 15 is disengaged from the female threaded socket 13. The bottom plate of the carriage portion 11a of the half rate carriage 11 includes a concave wall 16, which is indented into the carriage portion 11a generally in a truncated-cone shape. An annular neck 16a is provided in the top of the concave wall 16, and the female threaded socket 13 is provided on the inner surface of the annular neck 16a.

The securing screw 15 includes male threads 15a, which are screwed into the female threaded socket 13. The tip 15d of the male threads 15a is shaped with a partial spherical surface so as to serve as a guiding members. The neck 15c between the male threads 15a and a head 15b has a suitable length so that the head 15b is located outside of the bottom plate 10b of the casing 10 with the male threads 15a being screwed into the female threaded socket 13. A snap ring 17 is fitted around the neck 15c in the vicinity of the male threads 15a. The outer diameter of the snap ring 17 is greater than the inner diameter of the through hole 14 in plate 106 through which the securing screw 15 is inserted so as to prevent the securing screw 15 from coming off the casing 10. A spring washer 18 is provided between the head 15b and the bottom plate 10b. The head 15b is knurled, for example, so as to facilitate clamping of the securing screw 15 with fingertips, etc., to rotate the securing screw 15.

The operation of the carriage securing structure having such a structure according to one embodiment of the present invention will now be described. In cases such as when moving the image processor from one place to another, the half rate carriage 11 can be secured in the casing 10 by moving the half rate carriage 11 to a position where the female threaded socket 13 faces the through hole 14 as illustrated in FIG. 3. The securing screw 15 is inserted through the through hole 14, and the securing screw 15 is stopped within the through hole 14 by the snap ring 17. The securing screw 15 is advanced through the through hole 14 while positioning the tip of the securing screw 15 within the concave wall 16. Since the spherical guiding member 15d is provided at the tip of the securing screw 15, the tip is guided to the female threaded socket 13 while sliding on the inner surface of the truncated-cone-shaped concave wall 16. Then, the head 15b can be rotated to screw the male threads 15a into the female threaded socket 13. After adequately tightening the securing screw 15, the half rate carriage 11 is held and secured by the securing screw 15. This prevents the half rate carriage 11 from being moved by vibrations, or the like, while moving the image processor from one place to another.

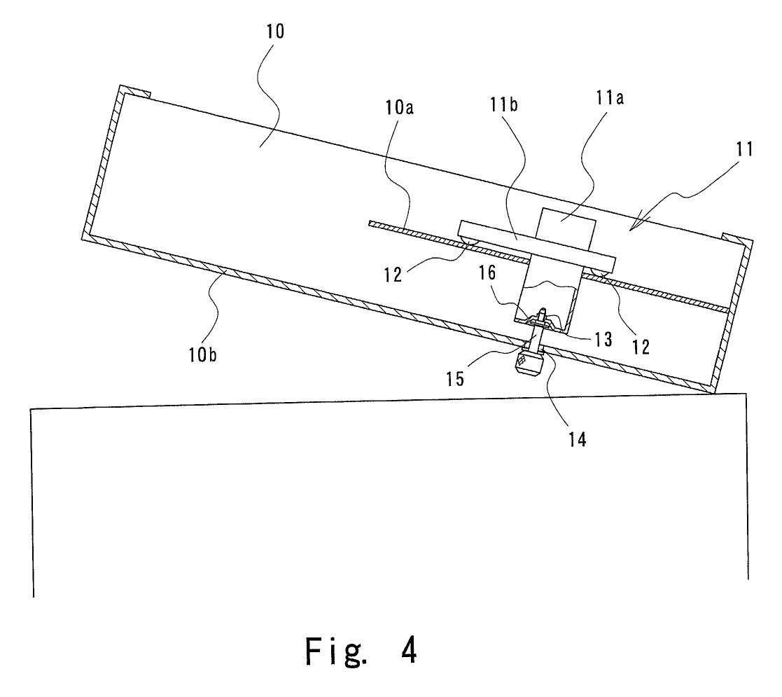

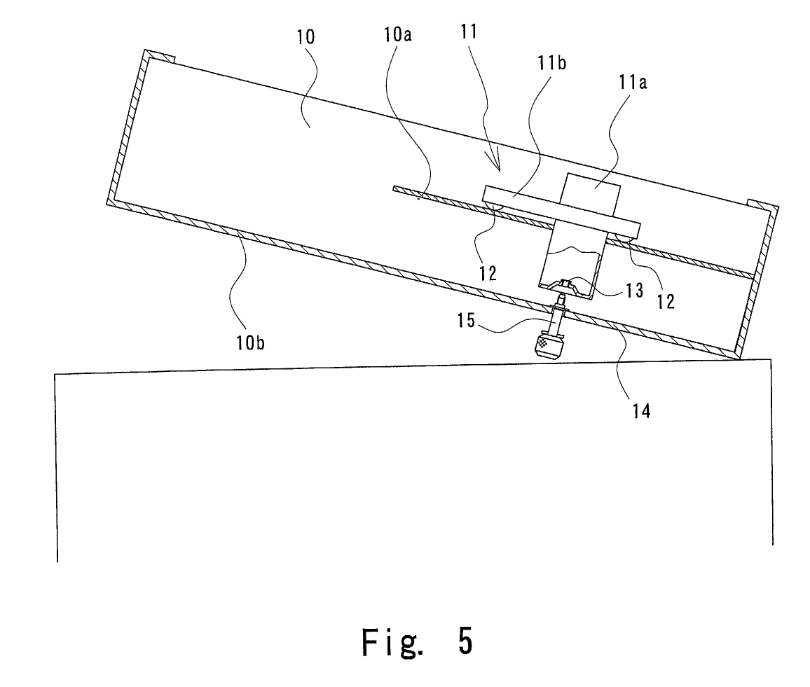

In order to release the half rate carriage 11, the casing 10 is adequately tilted so that the head 15b of the securing screw 15 can be clamped as illustrated in FIG. 4. Then, the head 15b of the securing screw 15 can be rotated to release the screw-engagement between the male threads 15a and the female threaded socket 13. Thus, the half rate carriage 11 is released to be movable as illustrated in FIG. 5. Then, the tilted casing 10 can be placed back into the original position.

While the half rate carriage 11 is movable, the securing screw 15 is free. However, as illustrated in FIG. 3, the snap ring 17 of the securing screw 15 is engaged with the bottom plate 10b of the casing 10 around the periphery of the through hole 14, thereby preventing the securing screw 15 from coming off the casing 10. Moreover, since the through hole 14 is closed by the snap ring 17, dust, or the like, is prevented from entering the casing 10 through the through hole 14. Furthermore, since the securing screw 15 stays on the casing 10, one can conveniently use the securing screw 15 to secure the half rate carriage 11 again. In addition, since the through hole 14 is provided in the bottom plate 10b, the through hole 14 and the securing screw 15 do not appear on the image processor after being installed. Thus, the appearance of the apparatus is not degraded.

While in the embodiment described above, the half rate carriage 11 is the subject to be secured, it is understood that the full rate carriage may alternatively be the subject to be secured. While in the embodiment described above, the securing screw 15 and the female threaded socket 13 are used as stop means and an engagement member, respectively, the mechanism is not limited to such a screw-based mechanism. For example, the stop means may alternatively be provided as a cylindrical rod with a key radially protruding from the outer surface of the rod, while the stop may be provided as a through hole defined by a circular shape through which the rod can be inserted and a key groove which is provided in a portion of the circular shape through which the key can be inserted. The key of the stop means can be passed through the stop by positionally aligning the key with the key groove, and then the rod can be adequately rotated so that the key is engaged with the stop which is provided in the carriage, thereby securing the carriage.

As described above, in the carriage securing structure for an image processor of the present invention, the stop means to be engaged with the engagement member provided in the carriage is provided while being linked with the bottom of the casing. Therefore, with the carriage being released, the through hole through which the stop means is inserted cannot be seen. Thus, the appearance of the image processor is not degraded. Moreover, since the stop means does not come off the bottom plate, the through hole through which the stop means is inserted is closed by the stop means, thereby preventing dust, or the like, from entering the casing through the through hole. Furthermore, since the stop means is linked with the bottom plate, the stop means cannot be seen whereby the appearance of the image processor is not degraded.

Moreover, the stop means and the engagement member are provided as a securing screw and a threaded portion, respectively, so that the stop means and the engagement member are engaged with and disengaged from each other by the screw-engagement/disengagement of the securing screw and the threaded socket. Therefore, one can conveniently secure and release the carriage.

Furthermore, the securing screw is provided as a male screw having a guiding member at the tip thereof, the guiding member being formed by a partial spherical surface, and the threaded socket is provided as a female threaded socket in the top of the concave wall indented into the carriage. Therefore, when one attempts to screw the securing screw into the threaded socket, the tip of the securing screw can be easily moved to the threaded socket while being guided along the inner surface of the concave wall. Thus, one can conveniently perform the securing of the carriage.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. A carriage securing structure for an image processor which obtains image information of an original by scanning the original while successively changing a position of illumination by moving a light source lamp mounted on a carriage in a casing having a bottom plate, the carriage securing structure comprising:
a stop which is captively coupled to the bottom plate of the casing for movement with respect to the bottom plate; and
an engagement member provided in the carriage, wherein the stop and the engagement member can be engaged with and disengaged from each other, such that the carriage is secured while the stop and the engagement member are engaged.

2. The carriage securing structure for an image processor according to claim 1, wherein:
the stop means is a screw; and
the engagement member is a threaded socket into which the screw is threaded.

3. The carriage securing structure for an image processor according to claim 2, wherein:
the screw is a male screw having a guiding portion at a tip portion thereof, the guiding portion being formed by a partial spherical surface; and
the threaded socket includes a concave wall provided in the carriage, the concave wall having a generally conical inner surface communicating with a female thread.

4. The carriage securing structure for an image processor according to claim 1, wherein the carriage is a half rate carriage.

5. The carriage securing structure for an image processor according to claim 2, wherein the carriage is a half rate carriage.

6. The carriage securing structure for an image processor according to claim 3, wherein the carriage is a half rate carriage.

7. The carriage securing structure for an image processor according to claim 1, wherein the carriage is a full rate carriage.

8. The carriage securing structure for an image processor according to claim 2, wherein the carriage is a full rate carriage.

9. The carriage securing structure for an image processor according to claim 3, wherein the carriage is a full rate carriage.

10. The carriage securing structure for an image processor according to claim 1, wherein the carriage comprises both a half rate carriage and a full rate carriage.

11. The carriage securing structure for an image processor according to claim 2, wherein the carriage comprises both a half rate carriage and a full rate carriage.

12. The carriage securing structure for an image processor according to claim 3, wherein the carriage comprises both a half rate carriage and a full rate carriage.

13. The carriage securing structure for an image processor according to claim 3 wherein said screw is captively held to said bottom plate by a snap ring.

14. The carriage securing structure for an image processor according to claim 13 wherein said screw has a head and further including a compression spring extending between said bottom plate and said head of said screw.

15. The carriage securing structure for an image processor according to claim 14 wherein said head of said screw is knurled.
